(19) United States
(12) Patent Application Publication
(10) Pub. No.: US 2012/0139184 A1
(43) Pub. Date: Jun. 7, 2012

(54) Dual Seal Tubing Hanger

(75) Inventor: Jimmy L. Kennedy, Kilgore, TX (US)

(73) Assignee: PETROHAWK PROPERTIES, LP, Houston, TX (US)

(21) Appl. No.: 12/961,603

(22) Filed: Dec. 7, 2010

(51) Int. Cl. E21B 33/10; B23P 11/02

(52) U.S. Cl. 277/336; 29/450

(57) ABSTRACT

A dual seal system and related method seal a tubing hanger. In an embodiment, a dual seal tubing hanger includes a hanger body. The dual seal tubing hanger also includes an upper body seal and an upper body seal ring. The upper body seal is disposed between the hanger body and the upper body seal ring. In addition, the dual seal tubing hanger includes a lower body seal and a lower body seal ring. The lower body seal is disposed between the lower body seal ring and the hanger body. The upper body seal and the upper body seal ring are disposed on an opposing end of the hanger body from the lower body seal and the lower body seal ring.

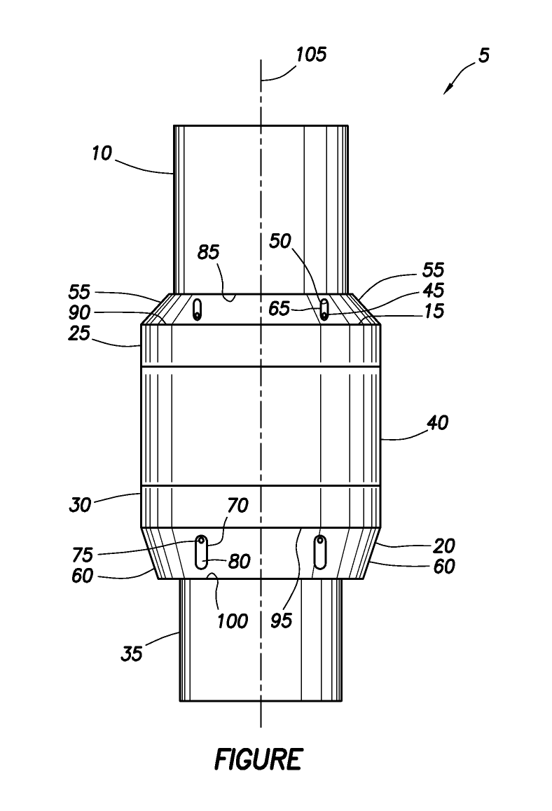

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to the field of wellbore equipment and more specifically to the field of seals for tubing hangers.

2. Background of the Invention

Tubing hangers are conventionally located in the tubing head and attached to the topmost tubing joint in the wellhead. Typically, the tubing hanger supports the tubing string weight. The tubing hanger also seals the annulus from the upper wellhead and Christmas tree.

Tubing hangers have sealing systems. Such sealing systems include a variety of seals. The conventional sealing systems include one seal. Drawbacks to having one seal include that if the one seal fails, the tubing hanger will lose its seal. Further drawbacks to conventional seals include the use of mud to kill the well, with the seal then typically being used. Killing the well with mud may be expensive and may also be dangerous to the wellbore. Further drawbacks include adding a frac valve to the top of the tubing hanger, with frac valves typically increasing costs.

Consequently, there is a need for improved sealing of tubing hangers.

### BRIEF SUMMARY OF SOME OF THE PREFERRED EMBODIMENTS

These and other needs in the art are addressed in one embodiment by a dual seal tubing hanger. The dual seal tubing hanger includes a hanger body. The dual seal tubing hanger also includes an upper body seal and an upper body seal ring. The upper body seal is disposed between the hanger body and the upper body seal ring. In addition, the dual seal tubing hanger includes a lower body seal and a lower body seal ring. The lower body seal is disposed between the lower body seal ring and the hanger body. The upper body seal and the upper body seal ring are disposed on an opposing end of the hanger body from the lower body seal and the lower body seal ring.

These and further needs in the art are addressed in another embodiment by a method for providing dual seals to a tubing hanger to provide a dual seal tubing hanger. The tubing hanger comprises an upper body seal ring, an upper body seal, a lower body seal, and a lower body seal ring. The method includes moving the upper body seal ring relative to a longitudinal axis of the tubing hanger. The method also includes compressing the upper body seal to form an upper seal. Movement of the upper body seal ring compresses the upper body seal. In addition, the method includes moving the lower body seal ring relative to the longitudinal axis of the tubing hanger. The method further includes compressing the lower body seal to form a lower seal. Movement of the lower body seal ring compresses the lower body seal.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which the FIGURE illustrates a tubing hanger with an upper body seal and a lower body seal.

### DETAILED DESCRIPTION OF THE PREFERRED EMBODIMENTS

The FIGURE illustrates an embodiment of a dual seal tubing hanger 5 having an upper body seal 25, a lower body seal 30, and a hanger body 40. In embodiments, lower body seal 30 is weight energized, and upper body seal 25 is energized by upper body seal motion means 65 (i.e., by upper body pin 45). Without limitation, dual seal tubing hanger 5 having upper body seal 25 and lower body seal 30 allows sealing without killing the well with mud. In addition, without limitation, dual seal tubing hanger 5 may be used and a seal may be maintained without a frac valve disposed on top of dual seal tubing hanger 5. Upper body seal 25 and lower body seal 30 provide dual seal tubing hanger 5 with two separate and independent seals.

In an embodiment as shown, dual seal tubing hanger 5 has upper extended portion 10. Without limitation, upper extended portion 10 is an extended neck of dual seal tubing hanger 5. In embodiments, upper extended portion 10 is composed of the same material as hanger body 40. In alternative embodiments, upper extended portion 10 and hanger body 40 are composed of different materials. Upper extended portion 10 may have any configuration suitable for attachment to desired equipment such as the adapter of the Christmas tree.

In embodiments, upper body seal ring 15 is disposed between upper extended portion 10 and upper body seal 25. In some embodiments, upper body seal ring 15 is composed of the same material as hanger body 40. In alternative embodiments, upper body seal ring 15 is composed of different materials than hanger body 40. Upper body seal ring 15 includes upper body seal motion means 65. Upper body seal motion means 65 may include any means suitable for allowing upper body seal ring 15 to move up and down (i.e., longitudinally in relation to dual seal tubing hanger 5). Upper body seal ring 15 is moveable up and/or down relative to longitudinal axis 105 of dual seal tubing hanger 5. In an embodiment as shown, upper body seal motion means 65 includes upper body pins 45 and upper body slots 50. In embodiments, upper body pins 45 are secured to a mandrel (not illustrated) disposed within hanger body 40. In an embodiment, upper body pins 45 are stationary in relation to movement of upper body seal ring 15. In such embodiments, upper body pins 45 extend from the side shown in the FIGURE to the opposing side (not illustrated) of upper body seal ring 15. Upper body slots 50 are openings in upper body seal ring 15. In embodiments, upper body slots 50 extend from the side shown in the FIGURE to the opposing side (not illustrated) of upper body seal ring 15. Without limitation, upper body slots 50 allow upper body seal ring 15 to move up and/or down along upper body pins 45. In embodiments, upper body seal ring 15 may move up and/or down for about the length of upper body slots 50. In an embodiment, upper body slots 50 have about the same length. Without limitation, each upper body slot 50 having about the same longitudinal length and longitudinal position facilitates about even movement up and/or down of each side of upper body seal ring 15 relative to upper body pins 45. In an embodiment as shown, upper body seal ring 15 has two upper body pins 45 and two corresponding upper body slots 50. In embodiments, each upper body slot 50 is disposed horizontally about 90 degrees from another upper body slot 50. Without limitation, disposing each upper body slot 50 horizontally about 90 degrees from another upper body slot 50 facilitates weight bearing. It is to be understood that upper body seal ring 15 is not limited to two upper body pins 45 but in alternative embodiments (not illustrated), upper body seal ring 15 may have one upper body pin 45 or more than two upper body pins 45 with the corresponding upper body slots 50.

As further shown in the FIGURE, upper body seal ring 15 has upper body slanted sides 55. In the embodiment as shown, upper body seal ring 15 has upper body seal ring top portion 85 and upper body seal ring bottom portion 90. As shown, upper body seal ring bottom portion 90 has a larger diameter than upper body seal ring top portion 85. In embodiments, upper body slanted side 55 extends outward from upper body seal ring top portion 85 to upper body seal ring bottom portion 90. In such embodiments, upper body slanted side 55 extends from upper body seal ring top portion 85 at an angle greater than 90 degrees, and upper body slanted side 55 has an angle to upper body seal ring bottom portion 90 less than 90 degrees.

In embodiments as shown, upper body seal 25 is disposed between upper body seal ring 15 and hanger body 40. Upper body seal 25 may comprise any elastomeric materials suitable for use in a wellbore. Upper body seal 25 is compressible. Compression of upper body seal 25 provides an upper seal to dual seal tubing hanger 5. Upper body seal 25 may be placed on dual seal tubing hanger 5 by any suitable means. In an embodiment, upper body seal 25 is slidable on to the upper portion of hanger body 40.

Hanger body 40 may be composed of any material suitable for use with tubing hangers in a wellbore. In embodiments as shown in the FIGURE, hanger body 40 has upper body seal 25 and lower body seal 30 on opposing sides of hanger body 40. Lower body seal 30 is disposed between hanger body 40 and lower body seal ring 20. Lower body seal 30 may comprise any elastomeric materials suitable for use in a wellbore. Lower body seal 30 is compressible. Compression of lower body seal 30 provides a lower seal to dual seal tubing hanger 5. Lower body seal 30 may be placed on dual seal tubing hanger 5 by any suitable means. In an embodiment, lower body seal 30 is slidable on to the lower portion of hanger body 40.

Embodiments of dual seal tubing hanger 5 as shown in the FIGURE include dual seal tubing hanger 5 having lower body seal ring 20. Lower body seal ring 20 is disposed between lower extended portion 35 and lower body seal 30. In embodiments, lower body seal ring 20 is composed of the same material as hanger body 40. In alternative embodiments, lower body seal ring 20 is composed of different materials than hanger body 40. Lower body seal ring 20 includes lower body seal motion means 70. Lower body seal motion means 70 may include any means suitable for allowing lower body seal ring 20 to move up and down (i.e., longitudinally in relation to dual seal tubing hanger 5). Lower body seal ring 20 is moveable up and/or down relative to longitudinal axis 105 of dual seal tubing hanger 5. In an embodiment as shown, lower body seal motion means 70 includes lower body pins 75 and lower body slots 80. In embodiments, lower body pins 75 are secured to a mandrel (not illustrated) disposed within hanger body 40. In an embodiment, lower body pins 75 are stationary in relation to movement of lower body seal ring 20. In such embodiments, lower body pins 75 extend from the side shown in the FIGURE to the opposing side (not illustrated) of lower body seal ring 20. Lower body slots 80 are openings in lower body seal ring 20. In embodiments, lower body slots 80 extend from the side shown in the FIGURE to the opposing side (not illustrated) of lower body seal ring 20. Without limitation, lower body slots 80 allow lower body seal ring 20 to move up and/or down along lower body pins 75. In embodiments, lower body seal ring 20 may move up and/or down for about the length of lower body slots 80. In an embodiment, lower body slots 80 have about the same length. Without limitation, each lower body slot 80 having about the same longitudinal length and longitudinal position facilitates about even movement up and/or down of each side of lower body seal ring 20 relative to lower body pins 75. In an embodiment as shown, lower body seal ring 20 has two lower body pins 75 and two corresponding lower body slots 80. In embodiments, each lower body slot 80 is disposed horizontally about 90 degrees from another lower body slot 80. Without limitation, disposing each lower body slot 80 horizontally about 90 degrees from another lower body slot 80 facilitates weight bearing. It is to be understood that lower body seal ring 20 is not limited to two lower body pins 75 but in alternative embodiments (not illustrated), lower body seal ring 20 may have one lower body pin 75 or more than two lower body pins 75 with the corresponding lower body slots 80.

As further shown in the FIGURE, lower body seal ring 20 has lower body slanted sides 60. In the embodiment as shown, lower body seal ring 20 has lower body seal ring top portion 95 and lower body seal ring bottom portion 100. As shown, lower body seal ring top portion 95 has a larger diameter than lower body seal ring bottom portion 100. In embodiments, lower body slanted side 60 extends outward from lower body seal ring top portion 95 to lower body seal ring bottom portion 100. In such embodiments, lower body slanted side 60 extends from lower body seal ring top portion 95 at an angle less than 90 degrees, and lower body slanted side 60 has an angle to lower body seal ring bottom portion 100 greater than 90 degrees.

In an embodiment as shown, dual seal tubing hanger 5 has lower extended portion 35. In embodiments, lower extended portion 35 is composed of the same material as hanger body 40. In alternative embodiments, lower extended portion 35 and hanger body 40 are composed of different materials. Lower extended portion 35 may have any configuration suitable for attachment to the tubing. For instance, without limitation, lower extended portion 35 has a suitable configuration by which the tubing is screwed into lower extended portion 35 and thereby connected to dual seal tubing hanger 5.

In an embodiment, operation of dual seal tubing hanger 5 includes attachment of the tubing spool of the Christmas tree (not illustrated) to the dual seal tubing hanger 5. In embodiments, when the tubing spool comes down, portions of the tubing spool contact upper body slanted sides 55. For instance, in some embodiments, the tubing spool has a series of pins machined through the side of the tubing spool. When the tubing spool comes down, the pins contact upper body slanted sides 55. The force of the contact of the portions of the tubing spool (i.e., the pins) on upper body slanted sides 55 causes upper body seal ring 15 to slide downward, with upper body slots 50 moving longitudinally along the stationary upper body pins 45. The downward movement of upper body seal ring 15 causes upper body seal 25 to compress and thereby form a seal. In some embodiments, upper body slanted sides 55 are configured to have a size sufficient to contact such pins. Operation of dual seal tubing hanger 5 also includes attachment of tubing to the dual seal tubing hanger 5. In embodiments, portions of the tubing contact the lower body slanted sides 60. For instance, the tubing has a tubing head with load bearing shoulders (not illustrated). In such embodiments, the load bearing shoulders contact the lower body slanted sides 60, and the tubing is secured to dual seal tubing hanger 5. The tubing may be secured to dual seal tubing hanger 5 by any suitable means. For instance, in an embodiment, the tubing is secured to dual seal tubing hanger 5 by screwing the tubing and lower extended portion 35 together. The force of the contact of the portions of the tubing (i.e., load bearing shoulders) on lower body slanted sides 60 when the tubing is secured to dual seal tubing hanger 5 (i.e., screwed into lower extended portion 35) causes lower body seal ring 20 to slide upward, with the lower body slots 80 moving longitudinally along the stationary lower body pins 75. Without limitation, actuation of movement of lower body seal ring 20 is weight energized (i.e., actuated) by the weight of the tubing. The upward movement of lower body seal ring 20 causes lower body seal 30 to compress and thereby form a seal. The seals provided by compression of upper body seal 25 and lower body seal 30 provide a dual seal for dual seal tubing hanger 5, with each seal on opposing ends of dual seal tubing hanger 5.

In alternative embodiments (not illustrated), upper body seal motion means 65 and/or lower body seal motion means 70 are a snap-ring retaining system instead of comprising upper body pins 45, lower body pins 75 and the corresponding upper body slots 50, lower body slots 80. It is to be further understood that in some embodiments, dual seal tubing hanger 5 is part of a wellhead assembly.

Although the present invention and its advantages have been described in detail, it should be understood that various changes, substitutions and alterations may be made herein without departing from the spirit and scope of the invention as defined by the appended claims.

What is claimed is:

1. A dual seal tubing hanger, comprising:
a hanger body;
an upper body seal and an upper body seal ring, wherein the upper body seal is disposed between the hanger body and the upper body seal ring;
a lower body seal and a lower body seal ring, wherein the lower body seal is disposed between the lower body seal ring and the hanger body; and
wherein the upper body seal and the upper body seal ring are disposed on an opposing end of the hanger body from the lower body seal and the lower body seal ring.

2. The dual seal tubing hanger of claim 1, further comprising an upper extended portion on an end of the dual seal tubing hanger distal from the lower body seal ring.

3. The dual seal tubing hanger of claim 1, wherein the upper body seal ring comprises an upper body seal motion means, and wherein the lower body seal ring comprises a lower body seal motion means.

4. The dual seal tubing hanger of claim 1, wherein the upper body seal ring comprises an upper body pin and an upper body slot, and wherein the upper body pin and the upper body slot extend from a side of the upper body seal ring to an opposing side of the upper body seal ring, and further wherein the upper body pin is disposed in the upper body slot.

5. The dual seal tubing hanger of claim 4, wherein the upper body pin is stationary in relation to the upper body seal ring, and wherein the upper body seal ring is moveable with respect to the upper body pin.

6. The dual seal tubing hanger of claim 1, wherein the upper body seal ring is moveable relative to a longitudinal axis of the dual seal tubing hanger.

7. The dual seal tubing hanger of claim 6, wherein the upper body seal is compressible by movement of the upper body seal ring.

8. The dual seal tubing hanger of claim 1, wherein the lower body seal ring comprises a lower body pin and a lower body slot, and wherein the lower body pin and the lower body slot extend from a side of the lower body seal ring to an opposing side of the lower body seal ring, and further wherein the lower body pin is disposed in the lower body slot.

9. The dual seal tubing hanger of claim 8, wherein the lower body pin is stationary in relation to the lower body seal ring, and wherein the lower body seal ring is moveable with respect to the lower body pin.

10. The dual seal tubing hanger of claim 1, wherein the lower body seal ring is moveable relative to a longitudinal axis of the dual seal tubing hanger.

11. The dual seal tubing hanger of claim 10, wherein the lower body seal is compressible by movement of the lower body seal ring.

12. The dual seal tubing hanger of claim 1, further comprising an upper extended portion, wherein the upper body seal ring is disposed between the upper extended portion and the upper body seal.

13. The dual seal tubing hanger of claim 1, further comprising a lower extended portion, wherein the lower body seal ring is disposed between the lower body seal and the lower extended portion.

14. The dual seal tubing hanger of claim 1, wherein the upper body seal ring comprises an upper body seal ring top portion and an upper body slanted side, and wherein the upper body slanted side comprises an angle in relation to the upper body seal ring top portion greater than 90 degrees.

15. The dual seal tubing hanger of claim 1, wherein the lower body seal ring comprises a lower body seal ring top portion and a lower body slanted side, and wherein the lower body slanted side comprises an angle in relation to the lower body seal ring top portion less than 90 degrees.

16. A method for providing dual seals to a tubing hanger to provide a dual seal tubing hanger, wherein the tubing hanger comprises an upper body seal ring, an upper body seal, a lower body seal, and a lower body seal ring, comprising:
(A) moving the upper body seal ring relative to a longitudinal axis of the tubing hanger;
(B) compressing the upper body seal to form an upper seal, wherein movement of the upper body seal ring compresses the upper body seal;
(C) moving the lower body seal ring relative to the longitudinal axis of the tubing hanger; and
(D) compressing the lower body seal to foam a lower seal, wherein movement of the lower body seal ring compresses the lower body seal.

17. The method of claim 16, further comprising contacting the upper body seal ring with a portion of a tubing spool to move the upper body seal ring.

18. The method of claim 17, wherein the upper body seal ring comprises an upper body slanted side, and wherein the portion of the tubing spool contacts the upper body slanted side.

19. The method of claim 16, wherein the tubing hanger comprises a lower extended portion, and wherein the method further comprises attaching tubing to the lower extended portion to actuate movement of the lower body seal ring.

20. The method of claim 19, wherein the tubing comprises a weight, and wherein the weight of the tubing actuates movement of the lower body seal ring.
